(19) United States
(12) Patent Application Publication
(10) Pub. No.: US 2012/0112091 A1
(43) Pub. Date: May 10, 2012

(54) METHOD FOR ADJUSTING STATUS OF PARTICLE BEAMS FOR PATTERNING A SUBSTRATE AND SYSTEM USING THE SAME

(75) Inventors: Kuen-Yu Tsai, Taipei (TW); Sheng-Yung Chen, Taipei (TW)

(73) Assignee: National Taiwan University, Taipei City (TW)

(21) Appl. No.: 13/286,450

(22) Filed: Nov. 1, 2011

Related U.S. Application Data
(60) Provisional application No. 61/410,295, filed on Nov. 4, 2010.
(60) Provisional application No. 61/431,063, filed on Jan. 10, 2011.

(51) Int. Cl. H01J 3/14; H01J 3/26; B01J 19/08; G21K 5/00

(52) U.S. Cl. 250/397; 250/492.22

(57) ABSTRACT

This invention provides a system capable of adjusting status of one or a plurality of particle beams, the system includes a plurality of particle detectors, an estimating unit and a controller, wherein one or a plurality of particle beams are projected to a substrate. The particle detectors detect the one or the plurality of particle beams reflected from the substrate to generate one or a plurality of detector signals in response thereto. The estimating unit estimates status information of the one or the plurality of particle beams by executing a mathematical method according to the one or the plurality of detector signals. The controller adjusts or corrects status of the one or the plurality of particle beams corresponding to the substrate according to the estimated status information of the one or the plurality of particle beams. The substrate is made pattern progressively in a sequence according to a desired pattern.

### CROSS REFERENCE TO RELATED APPLICATIONS

This application claims the benefit of U.S. Provisional Application No. 61/410,295, filed on Nov. 4, 2010, and U.S. Provisional Application No. 61/431,063, filed on Jan. 10, 2011, the contents of which are incorporated herein by reference.

### BACKGROUND OF THE INVENTION

1. Field of the Invention

The present invention relates to a system capable of adjusting status of one or a plurality of particle beams for patterning a substrate and a method for adjusting status of one or a plurality of particle beams for patterning a substrate.

2. Description of the Prior Art

Microlithography, a process for transferring desired patterning information to a wafer, is one of the most critical processes in integrated circuit fabrication. Currently, the mainstream technology for high-volume manufacturing of integrated circuits utilizes optical projection lithography with 193 nm deep ultraviolet laser and water immersion. Its resolution, mainly limited by optical diffraction, has been pushed below 45 nm in half-pitch. However, associated mask complexity and cost have grown prohibitive partly because strong resolution enhancement techniques such as multiple patterning are required to compensate for the diffraction effects. Several next-generation lithography techniques are being investigated for the 22 nm half-pitch node and beyond. Electron beam lithography is one of the promising candidates to replace optical projection lithography because of its capability of high resolution and maskless operation.

Multiple-electron-beam-direct-write (MEBDW) lithography has been proposed and investigated to increase throughput. By utilizing micro-electromechanical system (MEMS) processes for fabricating electron optical systems, the dimension of an electron beam lithography system can be shrunk substantially. Theoretically, a massive amount of electron beams can be integrated and driven to expose the same wafer simultaneously. This architecture poses several engineering challenges to be conquered in order to achieve throughput comparable to optical projection lithography.

The beam quality of an electron beam lithography system can degrade due to various uncertain effects such as electron charging and stray field. In multiple-electron-beam systems, beam positioning drift problems can become quite serious due to heat dissipation and electron optical system (EOS) fabrication errors. Periodic recalibration with reference markers on the wafer has been utilized in single-beam systems to achieve beam placement accuracy.

However, it is difficult to extend technique of periodic recalibration for MEBDW because the complexity involves may increase significantly with beam numbers. In addition to the beam positioning drift, other beam status such as beam attitude/orientation, beam current, and beam shape need to be well controlled as well for maintaining a good patterning quality. Therefore, how to modify the current method and system for adjusting status of particle beams in MEBDW lithography as a method or a system which can adjusting multiple-beams and achieve beam placement accuracy has become an imminent task for the industry.

### SUMMARY OF THE INVENTION

The disclosure is directed to a method for adjusting status of one or a plurality of particle beams for patterning a substrate and a system using the same. The reflected one or a plurality of particle beams are detected by a plurality of particle detectors to generate a plurality of detector signals, and an estimating unit is used to estimate status information of the particle beams by executing a mathematical method according to the detector signals; and a controller is used to correct the status of the one or the plurality of particle beams according to the estimated status information.

According to a first aspect of the present disclosure, a system capable of adjusting status of one or a plurality of particle beams is provided. The system includes a plurality of particle detectors, an estimating unit and a controller, wherein one or a plurality of particle beams are projected to a substrate. The plurality of particle detectors detect the one or the plurality of particle beams reflected from the substrate to generate a plurality of detector signals in response thereto. The estimating unit estimates status information of the one or the plurality of particle beams by executing a mathematical method according to the plurality of detector signals. The controller adjusts or corrects the status of the one or the plurality of particle beams corresponding to the substrate according to the estimated status information of the one or the plurality of particle beams. With the one or the plurality of particle beams, the substrate is made pattern progressively in a sequence according to a desired pattern.

According to a second aspect of the present disclosure, a method for adjusting status of one or a plurality of particle beams is provided. The method includes the following steps: one or a plurality of particle beams is projected to a substrate; detecting the one or the plurality of particle beams reflected from the substrate by a plurality of particle detectors to generate a plurality of detector signals in response thereto; estimating status information of the one or the plurality of particle beams in by an estimating unit by executing a mathematical method according to the plurality of detector signals; and adjusting or correcting the status of the one or the plurality of particle beams according to the estimated status information of the one or the plurality of particle beams by a controller; wherein the substrate is made pattern progressively in a sequence according to a desired pattern.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a schematic view of a system capable of adjusting status of one or a plurality of particle beams for patterning a substrate.

FIG. 2A shows a schematic view of a two-dimensional array of particle detectors.

FIG. 2B shows a schematic view of a detector group grouped of the four particle detectors A-D.

FIG. 3 shows a flow chart of a method for adjusting status of one or a plurality of particle beams of the present invention.

### DETAILED DESCRIPTION OF THE PREFERRED EMBODIMENTS

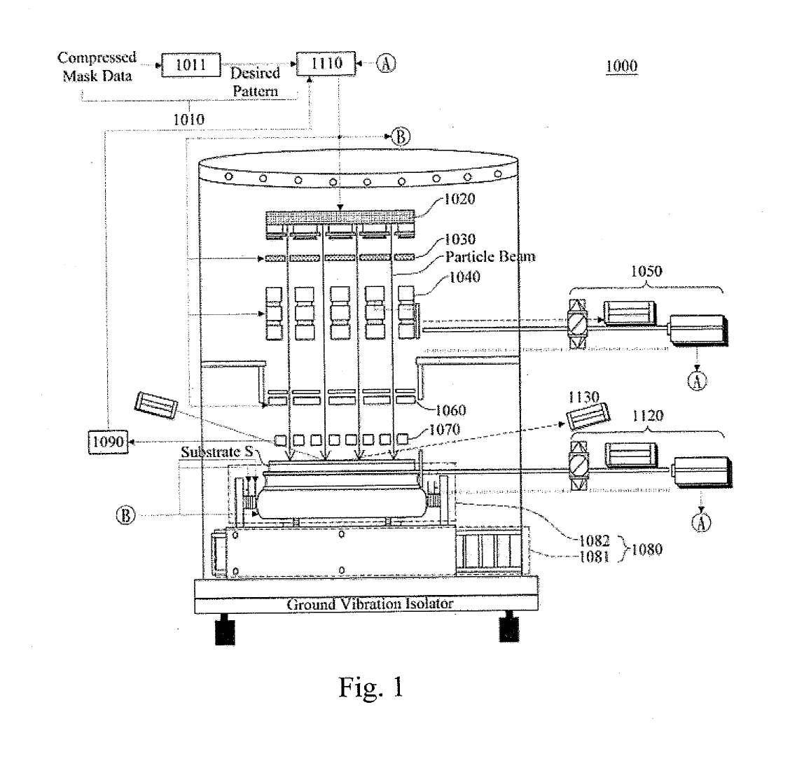

Referring to FIG. 1, which shows a schematic view of a system 1000 capable of adjusting status of one or a plurality of particle beams, wherein the one or a plurality of particle beams are projected to a substrate S, and the substrate S is made pattern progressively in a sequence according to a desired pattern. The particle beams can be photon beams, electron beams, ion beams or any combination thereof. The system 1000 includes a plurality of particle detectors 1070, an estimating unit 1090 and a controller 1110; in one embodiment, the system further includes a data transmission system 1010, a beam source 1020, a blanker array 1030, a focusing lens system 1040, a focusing lens system displacement detector 1050, a deflector array 1060, a substrate moving platform 1080, a substrate moving platform displacement detector 1120, a substrate focus leveling detector 1130, and a fixture used for fixing the substrate.

The data transmission system 1010, in one embodiment, includes a decoder 1011. In order to reduce the requirement of transmission bandwidth, layout information, such as a desired pattern which would be made on the substrate S, is compressed. Several compression techniques, such as JBIG or Block C4, are feasible approaches to achieve compression ratios more than 10 times. That is, the data transmission system 1010 is used for transmitting data for making pattern on the substrate, which are processed by using technology of data compression or data decoding, according to the desired pattern; and the compressed mask data is transmitted to the decoder 1011, then the decoder 1011 would decode the compressed data to generate and transmit a desired pattern to the controller 1110.

The beam source 1020 is the device which emits particle beams such as photon beams, electron beams, ion beams or any combination thereof, providing the one or the plurality of particle beams. The beam source 1020 can be divided into two types, one is the single-source type and the other is the multiple-source type. The single-source type is easy to maintain or replace when failure takes places, but it can be more difficult to achieve high particle flow density and brightness; besides, unwanted particle flow loss happens at beam splitting units. The multiple-source type can achieve high particle flow density and brightness more easily. The beam source 1020 could receive a control signal to provide one or a plurality of particle beams being projected to the substrate S, wherein the particle beams are substantially vertically projected to the substrate S. In one embodiment, each beam can be individually controlled with ON/OFF signals, and neighboring beams are substantially separated so that the interferences between the beams can be substantially reduced.

In one embodiment, the area of distribution of the particle beams is larger than one ten thousandth of the area of the substrate S; in another embodiment, the particle beams are distributed in a plurality of modules, the area of arrangement of the modules is larger than one ten thousandth of the area of the substrate S.

The particle detectors 1070, such as electron detectors, could detect the one or the plurality of particle beams reflected from the substrate S to generate a plurality of detector signals in response thereto. In one embodiment, the particle detectors 1070 could be disposed as an array of detectors placed above the substrate S, e.g. a wafer. In another embodiment, the particle detectors 1070 could be an array of quadrant-form two-dimensional detectors. The status of one or each of the particle beams is detected, in one embodiment, by at least two of the plurality of particle detectors 1070. In another embodiment, the status of one or each of the particle beams is detected by at least four of the plurality of particle detectors 1070.

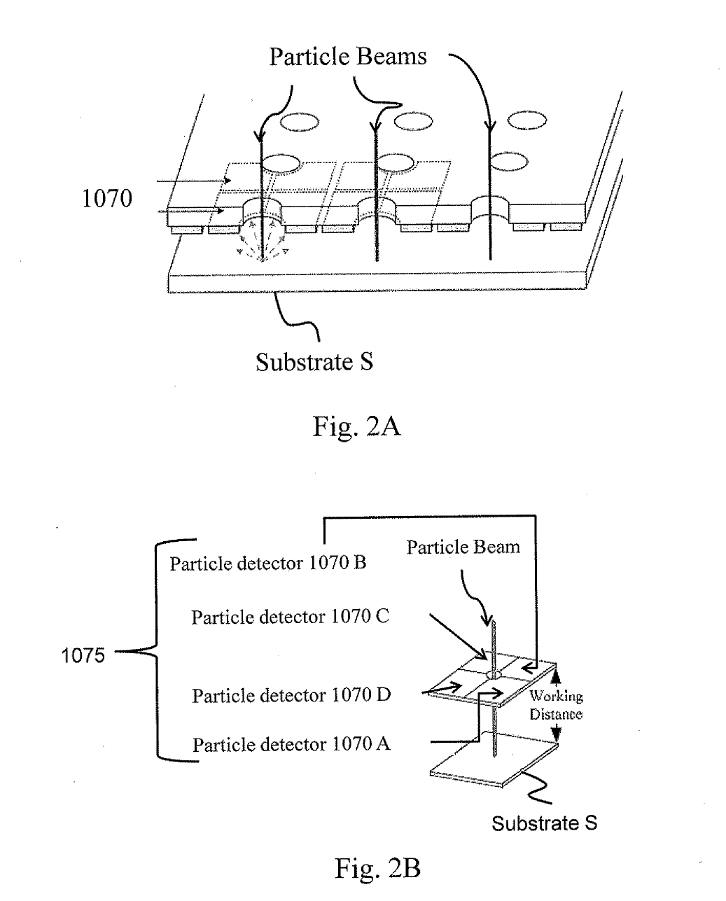

In one embodiment, refer to FIGS. 2A and 2B which shows a schematic view of a two-dimensional array of particle detectors 1070 and a schematic view of a detector group 1075 grouped of the four particle detectors A-D separately, every four of the particle detectors 1070, such as particle detectors 1070 A-D, are grouped in a quadrant-form so as to form one or a plurality of detector groups 1075, and the one or each of the particle beams is projected to the substrate S through a center part of one or each of the detector groups 1075, such that the four particle detectors 1070 of the detector group 1075 can sense the uneven backscattered particle distribution when the particle beam position is drifted from the central part. In another embodiment, the particle detectors 1070, less than four or more than four, could be grouped to form one or a plurality of detector groups, and the one or each of the detector groups corresponds to the one or each of the particle beams respectively, wherein the estimating unit 1090 estimates status information of the one or the plurality of particle beams according to output signals of the one or the plurality of detector groups.

The substrate focus leveling detector 1130 detects one or a plurality of surface measurement particle beams projected to the substrate, to measure surface profile of the substrate and determine whether the substrate is properly focused and leveled with respected to the one or the plurality of particle beams used for making the pattern. The one or the plurality of surface measurement particle beams can be photon beams, electron beams, ion beams or any combination thereof.

The estimating unit 1090, such as a signal processor, could estimates status information of the one or the plurality of particle beams by executing a mathematical method, such as a mathematical programming method, according to the plurality of detector signals. The status information of the particle beams, for example, could be the number of the reflected particles, particle energy, particle flux, the size, the shape, the position or the attitude of the particle beams. In one embodiment, the estimating unit 1090 also estimates the surface profile of the substrate according to the measured surface measurement particle beam detector signals by the substrate focus leveling detector 1130.

The controller 1110, such as an on-line feedback compensator, adjusts or corrects the status of the one or the plurality of particle beams according to the estimated status information of the one or the plurality of particle beams repeatedly during the duration time when pattern is made on the substrate by the one or the plurality of particle beams.

The blanker array 1030 is used for changing the particle flux of the one or each of the particle beams projected to the substrate according to a control signal, wherein the control signal is determined according to the desired pattern by the controller 1110.

The focusing lens system 1040 is controlled by the controller 1110 to change size or shape of the one or the plurality of particle beams according to a control signal, wherein the controller 1110 adjusts or corrects status of the one or the plurality of particle beams by changing the control signal according to the estimated status information of the one or the plurality of particle beams.

The deflector array 1060 is controlled by the controller 1110 to change position of the one or the plurality of particle beams projected to the substrate according to a control signal; wherein the controller 1110 adjusts or corrects the status of the one or the plurality of particle beams by changing the control signal according to the estimated status information of the one or the plurality of particle beams.

The substrate moving platform 1080, such as being placed under the substrate S, is driven by one or a plurality of force actuators, such as linear induction motors or piezoelectric motors. The substrate moving platform 1080, in one embodiment, includes a first sub-moving platform 1081 and a second sub-moving platform 1082; the first sub-moving platform 1081 is capable of moving with respect to the beam source 1020 for a substantially larger distance, the second sub-moving platform 1082 is capable of moving with respect to the beam source 1020 for a substantially smaller distance.

The controller 1110 controls at least one of the beam source 1020, the blanker array 1030, the focusing lens system 1040, the deflector array 1060 and the substrate moving platform 1080 to let the substrate S be made pattern progressively in a sequence according to a desired pattern. In one embodiment, the desired pattern is transmitted to the controller 1110, then the controller 1110 controls the beam source 1020 to provide one or a plurality of particle beams to be projected on the substrate S according to the desired pattern, and the blanker array 1030, the focusing lens system 1040 and the deflector array 1060 are controlled by the controller 1110 to make the status of the one or the plurality of particle beams more suitable for the desired pattern; for example, according to the desired pattern, the blanker array 1030 is controlled to change the particle flux of the one or each of the plurality of particle beams, the focusing lens system 1040 is controlled to change the size or the shape of the one or the plurality of particle beams, the deflector array 1060 is controlled to change the position of the one or the plurality of particle beams, and the substrate moving platform 1080 is controlled to adjust the position of the substrate S or to exchange a new substrate.

The focusing lens system displacement detector 1050 and the substrate moving platform displacement detector 1120 are used for measuring a displacement of the substrate moving platform 1080 relative to the focusing lens system 1040, wherein the controller 1110 can correct the displacement according to the measured displacement and the desired pattern by adjusting position of the substrate moving platform 1080, the control signal to the beam source 1020, the control signal to the blanker array 1030, or the control signal to the deflector array 1060, wherein the substrate S is made pattern progressively in a sequence according to a desired pattern.

Following is the description about how to adjust the status of the one or the plurality of particle beam when the pattern made on the substrate is different from the desired pattern.

The controller 1110 controls the beam source 1020, the blanker array 1030, the focusing lens system 1040, the deflector array 1060 and the substrate moving platform 1080 according to the desired pattern transmitted from the data transmission system 1010 to make the desired pattern on the substrate S. However, there are lots of reasons resulting the pattern made on the substrate S be different from the desired pattern, so the particle detectors 1070 are used for detecting the status change of the one or the plurality of particle beams to determine whether the status of the one or the plurality of particle beams should be adjusted.

The particle detectors 1070 would transmit the signal generated according to the one or the plurality of particle beams reflected from the substrate S to the estimating unit 1090, and the estimating unit 1090 estimates and transmits the status information by executing a mathematical method, such as a mathematical programming method, according to the plurality of detector signals, to the controller 1110.

When the controller 1110 receives the estimated status information of the one or the plurality of particle beams transmitted from the estimating unit 1090, the measured displacement signals from the substrate moving platform displacement detector 1120 and the measured displacement signals from the focusing lens system displacement detector 1050, the controller 1110 would analyze the collected data to obtain analysis result, such as the one or any one of the plurality of particle beams has drifted, the size, shape, particle flux or the particle energy of the one or any one of the plurality of particle beams has changed, or the substrate moving platform 1080 has been undesirably moved relative to the focusing lens system 1040. The analysis result is used by the controller 1110 to determine the adjustment of one or a plurality of control signals for the beam source 1020, the blanker array system 1030, the focusing lens system 1040, and the substrate moving platform 1080, to adjust or correct the status of the one or the plurality of particle beams appropriately.

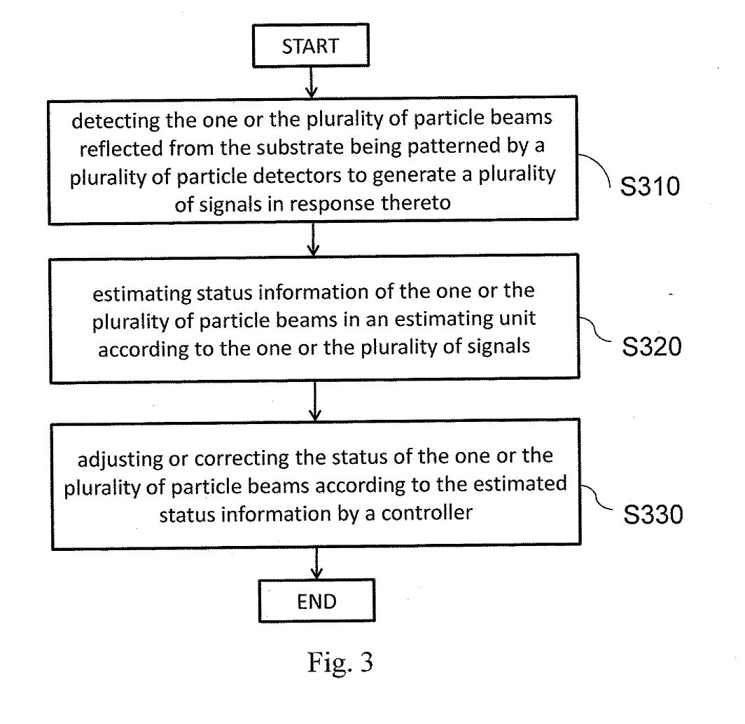

Refer to FIG. 3, which shows a flow chart of a method for adjusting status of one or a plurality of particle beams, wherein the one or the plurality of particle beams is being projected to a substrate S and the substrate S is made pattern progressively in a sequence according to a desired pattern.

In step S310, the one or the plurality of particle beams reflected from the substrate S is detected by a plurality of particle detectors 1070 to generate a plurality of detector signals in response thereto.

In step S320, status information of the one or the plurality of particle beams is estimated in an estimating unit 1090 by executing a mathematical method, such as a mathematical programming method, according to the one or the plurality of detector signals.

In step S330, status of the one or the plurality of particle beams is adjusted or corrected according to the information of the one or the plurality of particle beams by a controller 1110.

In step S330, there exists several methods to change the status of the one or the plurality of particle beams, for example, in the first embodiment, to change the particle flux of the one or the plurality of particle beams projected to the substrate S by a blanker array 1030 according to a control signal transmitted from the controller 1110.

In the second embodiment, to change the position of the one or the plurality of particle beams projected to the substrate S by a deflector array 1060 according to a control signal, wherein the controller 1110 adjusts or corrects status of the one or the plurality of particle beams by changing the control signal according to the estimated position deviation information of the particle beams.

In the third embodiment, to change the size or the shape of the one or the plurality of particle beams by a focusing lens system 1040 according to a control signal, wherein the controller 1110 adjusts or corrects status of the one or the plurality of particle beams by changing the control signal according to the information of the particle beams.

In the fourth embodiment, to change the position of the one or the plurality of particle beams projected to the substrate S, the controller 1110 adjusts or corrects status of the one or the plurality of particle beams by adjusting the substrate moving platform 1080 via the first sub-moving platform 1081 and/or a second sub-moving platform 1082. The displacement of the substrate moving platform 1080 relative to the focusing lens system 1040 is measured by a substrate moving platform displacement detector 1120 and a focusing lens system displacement detector 1050, wherein the position of the one or the plurality of particle beams is corrected by the controller 1110 according to the measured displacement and the desired pattern.

It is noted that although the methods used to change the status of the one or the plurality of particle beams are described herein in different embodiments, however, the methods in different embodiments could be used together. For example, the method, described in the first embodiment, used to change status of the one or the plurality of particle beams is to change the particle flux of the one or the plurality of particle beams by a blanker array system 1030, and the method, described in the second embodiment, used to change status of the one or the plurality of particle beams is to change position of the one or the plurality of particle beams by a deflector array 1060, however, the system 1000 could control the blanker array 1030 and the deflector array 1060 at the same time to change status of the one or the plurality of particle beams, such as particle flux and position of the one or the plurality of particle beams.

It is clear that the method for adjusting status of particle beams for patterning a substrate and system using the same of the present disclosure would adjust status of the one or the plurality of particle beams, such as the particle energy, particle flux, size, shape, position or attitude of the particle beams, repeatedly during the duration time when pattern is made on the substrate, to make the desired pattern made on the substrate more accurately.

In addition, the area of distribution of the particle beams is larger than the area of the desire pattern such that more than one copies of the desired pattern could be made pattern at the same time, this would reduce the requirement of the pattern data transmission and increase the production capacity.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system capable of adjusting status of one or a plurality of particle beams, comprising:
one or a plurality of particle beams being projected to a substrate;
a plurality of particle detectors, used for detecting the one or the plurality of particle beams reflected from the substrate to generate one or a plurality of detector signals in response thereto;
an estimating unit, used for estimating status of the one or the plurality of particle beams by executing a mathematical method according to the one or the plurality of detector signals; and
a controller, used for adjusting or correcting the status of the one or the plurality of particle beams according to the estimated status of the one or the plurality of particle beams;
wherein the substrate is made pattern progressively in a sequence according to a desired pattern.

2. The system capable of adjusting status of one or a plurality of particle beams of claim 1, wherein the status of the one or the plurality of particle beams is particle energy or particle flux of the one or each of the particle beams.

3. The system capable of adjusting status of one or a plurality of particle beams of claim 1, wherein the status of the one or the plurality of particle beams is size, shape, position or attitude of the one or each of the particle beams.

4. The system capable of adjusting status of one or a plurality of particle beams of claim 1, wherein the controller is an on-line feedback compensator and the on-line feedback compensator adjusts status of the particle beams repeatedly during the duration time when the desired pattern is made on the substrate by the one or the plurality of particle beams.

5. The system capable of adjusting status of one or a plurality of particle beams of claim 2, further comprising:
a beam source providing the one or the plurality of particle beams, used for changing the particle energy or the particle flux according to a control signal;
wherein the controller adjusts or corrects status of the one or the plurality of particle beams by changing the control signal according to the estimated status information of the one or the plurality of particle beams.

6. The system capable of adjusting status of one or a plurality of particle beams of claim 1, further comprising:
a blanker array, used for changing the particle flux of the one or each of the particle beams projected to the substrate according to a control signal;
wherein the control signal is determined according to the desired pattern.

7. The system capable of adjusting status of one or a plurality of particle beams of claim 1, further comprising:
a deflector array, used for changing position of the one or the plurality of particle beams projected to the substrate according to a control signal;
wherein the controller adjusts or corrects status of the one or the plurality of particle beams by changing the control signal according to the estimated status information of the one or the plurality of particle beams.

8. The system capable of adjusting status of one or a plurality of particle beams of claim 3, further comprising:
a focusing lens system, used for changing the size or the shape of the one or the plurality of particle beams according to a control signal;
wherein the controller adjusts or corrects status of the one or the plurality of particle beams by changing the control signal according to the estimated status information of the one or the plurality of particle beams.

9. The system capable of adjusting status of one or a plurality of particle beams of claim 1, further comprising:
a substrate moving platform, used for positioning the substrate;
wherein the controller adjusts or corrects status of the one or the plurality of particle beams by adjusting the substrate moving platform.

10. The system capable of adjusting status of one or a plurality of particle beams of claim 9, wherein the substrate moving platform is driven by one or a plurality of force actuators.

11. The system capable of adjusting status of one or a plurality of particle beams of claim 9, wherein the substrate moving platform has a first sub-moving platform and a second sub-moving platform, the first sub-moving platform is capable of moving a substantially larger distance, the second sub-moving platform is capable of moving a substantially smaller distance.

12. The system capable of adjusting status of one or a plurality of particle beams of claim 9, wherein the status of the one or the plurality of particle beams is size, shape, position or attitude of the one or each of the particle beams, the system further comprising:
a focusing lens system, used for changing size or shape of the one or the plurality of particle beams according to a control signal; and
a focusing lens system displacement detector and a substrate moving platform displacement detector, used for measuring a displacement of the substrate moving platform relative to the focusing lens system;
wherein the controller corrects the displacement according to the measured displacement and the desired pattern.

13. The system capable of adjusting status of one or a plurality of particle beams of claim 12, wherein controller corrects the displacement by adjusting position of the substrate moving platform.

14. The system capable of adjusting status of one or a plurality of particle beams of claim 12, further comprising:
a deflector array, used for adjusting positions of the one or the plurality of particle beams projected to the substrate according to a control signal;
wherein the controller corrects the displacement by adjusting the control signal.

15. The system capable of adjusting status of one or a plurality of particle beams of claim 12, wherein the controller corrects the displacement by rearranging the sequence.

16. The system capable of adjusting status of one or a plurality of particle beams of claim 1, wherein the status of the one or the plurality of particle beams is particle flux of the one or the plurality of particle beams; and the controller adjusts particle flux of the one or the plurality of particle beams according to estimate particle flux.

17. The system capable of adjusting status of one or a plurality of particle beams of claim 1, wherein the particle beams are photon beams, electron beams, ion beams or any combination thereof.

18. The system capable of adjusting status of one or a plurality of particle beams of claim 1, further comprising:
one or a plurality of surface measurement particle beams being projected to the substrate; and
one or a plurality of surface measurement particle beam detectors, used for measuring surface profile of the substrate to generate one or a plurality of surface measurement particle beam detector signals in response thereto;
wherein the one or the plurality of surface measurement particle beams are photon beams, electron beams, ion beams or any combination thereof, and the estimating unit estimates the surface profile of the substrate according to the one or the plurality of surface measurement particle beam detector signals.

19. The system capable of adjusting status of one or a plurality of particle beams of claim 1, further comprising:
a fixture, used for fixing the substrate.

20. The system capable of adjusting status of one or a plurality of particle beams of claim 1, further comprising:
a data transmission system, used for transmitting data for making pattern on the substrate according to the desired pattern, wherein the data transmission system processes the data by using technology of data compression or data decoding.

21. The system capable of adjusting status of one or a plurality of particle beams of claim 1, wherein the particle detectors are grouped so as to form one or a plurality of detector groups, the one or each of the plurality of detector groups corresponds to the one or each of the particle beams respectively, and the estimating unit estimates information of the one or the plurality of particle beams according to output signals of the one or the plurality of detector groups.

22. The system capable of adjusting status of one or a plurality of particle beams of claim 1, wherein the area of distribution of the particle beams is larger than one ten thousandth of the area of the substrate.

23. The system capable of adjusting status of one or a plurality of particle beams of claim 1, wherein the particle beams are distributed in a plurality of modules, the area of arrangement of the modules is larger than one ten thousandth of the area of the substrate.

24. A method for adjusting status of one or a plurality of particle beams, comprising:
one or a plurality of particle beams being projected to a substrate;
detecting the one or the plurality of particle beams reflected from the substrate by a plurality of particle detectors to generate one or a plurality of detector signals in response thereto;
estimating status information of the one or the plurality of particle beams in an estimating unit by executing a mathematical method according to the one or the plurality of detector signals; and
adjusting or correcting status of the one or the plurality of particle beams according to the estimated status information of the one or the plurality of particle beams by a controller;
wherein the substrate is made pattern progressively in a sequence according to a desired pattern.

25. The method for adjusting status of one or a plurality of particle beams of claim 24, further comprising:
changing the particle flux of the one or the plurality of particle beams projected to the substrate by a blanker array according to a control signal transmitted from the controller and determined according to the desired pattern.

26. The method for adjusting status of one or a plurality of particle beams of claim 24, further comprising:
changing position of the one or the plurality of particle beams projected to the substrate by a deflector array according to a control signal;
wherein the controller adjusts or corrects status of the one or the plurality of particle beams by changing the control signal according to the estimated status information of the one or the plurality of particle beams.

27. The method for adjusting status of one or a plurality of particle beams of claim 24, further comprising:
changing size or shape of the one or the plurality of particle beams by a focusing lens system according to a control signal;
wherein the controller adjusts or corrects status of the one or the plurality of particle beams by changing the control signal according to the estimated status information of the one or the plurality of particle beams.

28. The method for adjusting status of one or a plurality of particle beams of claim 24, further comprising:
placing the substrate on a substrate moving platform, wherein the controller adjusts or corrects status of the one or the plurality of particle beams by adjusting the substrate moving platform

29. The method for adjusting status of one or a plurality of particle beams of claim 28, wherein the substrate moving platform has a first sub-moving platform and a second sub-moving platform, the first sub-moving platform is capable of moving a substantially larger distance, the second sub-moving platform is capable of moving a substantially smaller distance.

30. The method for adjusting status of one or a plurality of particle beams of claim 28, wherein the status of the one or the plurality of particle beam is size, shape, position or attitude of the one or each of the particle beams, the method further comprising:
changing size and shape of the one or the plurality of particle beams by a focusing lens system according to a control signal;
measuring a displacement of the substrate moving platform relative to the focusing lens system by one or a plurality of displacement detectors; and
correcting the displacement by the controller according to the measured displacement and the desired pattern.

31. The method for adjusting status of one or a plurality of particle beams of claim 30, wherein the controller corrects the displacement by adjusting position of the substrate moving platform or the sequence.
